(19) United States
(12) Patent Application Publication
(10) Pub. No.: US 2023/0153920 A1
(43) Pub. Date: May 18, 2023

(54) SYSTEMS AND METHODS FOR SAFELY FACILITATING PHYSICAL CONNECTIONS

(71) Applicant: Downtime - A Social Calendar Inc., Rosemary Beach, FL (US)

(72) Inventor: Lisa STONER, Rosemary Beach, FL (US)

(73) Assignee: Downtime - A Social Calendar Inc., Rosemary Beach, FL (US)

(21) Appl. No.: 17/987,776

(22) Filed: Nov. 15, 2022

Related U.S. Application Data
(60) Provisional application No. 63/279,330, filed on Nov. 15, 2021.

(51) Int. Cl. G06Q 50/00; H04L 67/1021; H04L 67/306

(52) U.S. Cl. CPC G06Q 50/01; H04L 67/1021; H04L 67/306

(57) ABSTRACT

The invention comprises systems and methods for facilitating physical meetings amongst people via a provided mobile software application, wherein personal availabilities based on location and time are visible among permitted users and user groups. In certain embodiments, a system comprises a software application in network communication with a mobile device over an application programming interface (API), wherein a user of the mobile device may carry out a number of selected functions by interacting with an installed graphical user interface (GUI). In preferred embodiments, a system of the present invention is equipped with security features so users may select which other users have visibility to their plans and availabilities, as well as chat capability provided via short message service (SMS) text or the like for users who have identified potential opportunities for in-person meetings. It is an object of the invention to raise visibility among users of opportunities to meet.

### CROSS-REFERENCE TO RELATED APPLICATIONS

The present application claims the benefit of priority of U.S. Provisional Pat. App. 63/279,330, filed Nov. 15, 2021, the contents of which are incorporated herein by reference in their entirety.

### STATEMENT REGARDING FEDERALLY SPONSORED RESEARCH OR DEVELOPMENT

The present invention was developed without the benefit of federal funding.

### BACKGROUND OF THE INVENTION

Social media applications are rampant in the marketplace and provide communications that are used virtually by hundreds of millions of people. Yet there still exists a desire to strengthen existing connections, in real life, in the physical world. Many social media platforms allow for the formation of groups, wherein group members may inquire about the near- and long-term whereabouts of fellow group members so they can identify opportunities to connect in person when they are in close proximity of one another geographically and simultaneously. Unfortunately, many such opportunities are missed because currently available platforms rely to a great degree on the group members' attentiveness to postings from other members in time to connect in person. This mechanism is inefficient and inadvertently excludes people who may not be monitoring the group activities for various reasons.

People with busy lives do not have a means today for effectively facilitating social connections, which is a need in the art most recently having been punctuated by COVID-19 and various self-isolation practices that have taken place. Continuing to date, more people are working remotely and leading lives that are more nomadic, and relatively less predictable from a scheduling perspective than what was commonplace in 2019 and earlier. What once was a local office now has a much wider virtual radius, albeit at the expense of people losing the benefit of direct physical interaction with friends, family, colleagues and business associates. Thus, there has developed a need in the art for systems and methods that help more seamlessly and efficiently provide people with an opportunity to connect in person. Indeed, many people are lonelier than ever and there has never been a greater collective desire for a way to make safe, personal connections.

Existing calendars or social media applications are significantly more limited in scope and are based either in real time (where people are now), single events only (invited to dinner), etc. No application acts as an aggregator of actual plans, future options and planned locations of multiple types of contacts including permission-based messaging functions. The invention of the present disclosure comprises such capabilities and thus serves the need for such functionality in a simple, low-effort, safe, personal, private and convenient way.

### BRIEF SUMMARY OF THE INVENTION

The invention of the present disclosure is that of systems and methods for seamlessly facilitating safe physical connections between people who are not always in the same place at the same time but would like to connect when they are. It is one object of the invention to allow group members (friends, families, classmates, colleagues, etc.) to provide visibility as to their locations and “open times”, defined herein as times during which they have no preexisting commitments and are available for interaction. This functionality may be current or forward-looking, i.e., when people will be in certain locations and when they have downtime for unplanned meetings and interactions.

In a preferred embodiment, a system of the present disclosure is in the form of a mobile software application (“mobile app” or simply “app”) and application program interface (API) that enables interaction through a graphical user interface (GUI) visible on a portable electronic device such as a smartphone or tablet. Users, through the GUI, may log in, create profiles, invite other users to connect, set up groups, view connections' plans, request meetings, create plans and share plans, all securely and based on customizable permission settings. The invention leverages known client-server architectures and cloud computing to enable the functionality of the mobile app. The back end of the system architecture may include a database and memory, each in communication with a software application tangibly stored on a non-transitory computer readable medium, comprising administrator and user APIs, enabling front-end communications with administrator and user devices, respectively. As one of ordinary skill in the art will appreciate, this architecture enables administrators to push updates out so users can experience them seamlessly.

It is contemplated according to the present disclosure that group members suitably situated for connection may then open up a “chat” (i.e., via short message service (SMS) text according to communications protocols that will be readily understood by one of ordinary skill in the art). It is an object of the present invention to allow this to occur securely, and that users of a software application as described herein may set different permissions in terms of who may view which parameters that are available for display. It is an object of the invention to greatly simplify planning processes and facilitate in-person connections and communications differently by aggregating information and planning differently than any existing solution today. For example, by allowing visibility, in list view, by city, which contacts a user may have that reside in that city from a variety of sources linked to the application (e.g., professional, academic and social media inputs). These and other benefits of the present invention are described in more detail in the disclosure that follows.

### BRIEF DESCRIPTION OF THE DRAWINGS

FIG. 1 illustrates an exemplary application architecture according to an embodiment a system of the present disclosure.

FIG. 2 illustrates a client-server architecture according to an embodiment of a system of the present disclosure.

FIG. 3 illustrates a representational state transfer (REST) architecture according to an embodiment of a system of the present disclosure.

FIG. 4 illustrates a cloud-based implementation of according to an embodiment of a system of the present disclosure.

FIGS. 5A and 5B illustrate a screen shots for logging into a system and verifying identity, respectively, according to an embodiment of the present disclosure.

FIGS. 6A-6C illustrate screen shots for setting up a profile, adding or referring friends and selecting friends to add, respectively, according to an embodiment of the present disclosure.

FIGS. 7A-7C illustrate screen shots for adding friends from certain groups, viewing a group and adding friends to the group, respectively, according to an embodiment of the present disclosure.

FIG. 8 illustrates a screen shot for creating a group according to an embodiment of the present disclosure.

FIGS. 9A and 9B illustrate screen shots where people traveling can be viewed and filtered, respectively, according to an embodiment of the present disclosure.

FIG. 10A-C illustrates a screen shot for setting up a user profile according to an embodiment of the present disclosure.

FIG. 11 illustrates a screen shot where a request to meet may be entered based on the information described with reference to FIGS. 10A-10C, according to an embodiment of the present disclosure.

FIGS. 12A-12D illustrate screen shots where plans may be entered, including travel, and made visible to connections who may then request meetings during downtimes.

FIGS. 13A and 13B illustrate screen shots where a meeting may be requested and a chat started about said meeting, respectively.

### DETAILED DESCRIPTION OF ILLUSTRATIVE EMBODIMENTS

The invention of the present disclosure is that of systems and methods for safely facilitating physical connections inspired by the ever-increasing need for such connections in the wake of a global pandemic. The systems and methods described herein provide a mechanism to strengthen connections and increase the frequency of visits for familiar people in a world where people have increasingly unpredictable schedules. It is an object of the invention to aggregate peoples' current plans simply, reducing the logistical challenges of coordinating both planned and spontaneous social activities.

For example, in preferred embodiments, users of a system according to the present disclosure can be notified when people in their various social, academic, or family circles will be in the same geographic area, or when they plan to be. This can be done as generally or specifically as a user prefers. In preferred embodiments, screen views on a mobile app according to the present disclosure may include calendars and maps, either native or accessed via web services over the Internet or similar communications network, where users may see their connections' plans and locations. Thus, it is an object of the present invention to remove obstacles to connecting with people in person by reducing the barrier to entering into plans. More specifically, it is an object of the invention to reduce the formality of invitations by allowing people to display openness to plans without having to formally accept or decline. By enabling various groups to be set up, efficiencies of connection are achieved across age groups and connection types; i.e., some activities are appropriate for entire families, while other may be adult only or youth only in appropriateness.

It is an object of the present invention to safely facilitate reconnections to friends and professional colleagues who may have been in various states of relative isolation since early 2020 by making it easier to schedule and connect with people based on “downtimes”. This environment creates options for people to connect rather than increasing their obligations to do so, which tends to be the case with mobile apps in the current state of the art. Selected contacts may be notified when their connections are in town, currently or in the future. In a preferred embodiment, connections from various social media or contact platforms may be imported into a system according to the present disclosure to reduce ramp-up time for new users. In preferred embodiments, SMS text functionality is enabled for users who have opted into the same connection. A mobile app according to the present disclosure is designed to encourage face-to-face meetings, foster community, and create opportunities—as opposed to obligations—to meet by providing calendar views for individuals across the globe.

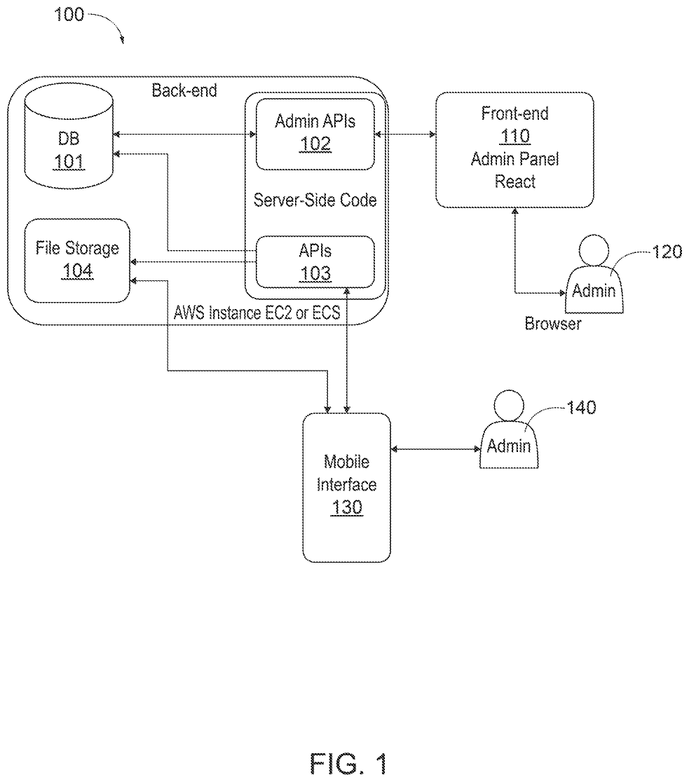

To enable the features described herein, systems and methods are required which are best described with reference to the accompanying drawings. Beginning with FIG. 1, an application architecture is illustrated, comprising back-end components with Admin APIs for front-end access by a system administrator enabling the seamless updating and patching of the system as will be understood by one of ordinary skill in the art. An exemplary back end is made available on a web server 100 and comprises a database (DB) 101 such as but not limited to a MySQL DB, which may be accessed via front-end Admin Panel 110 and Admin APIs 102 by an administrator using an available web browser 120, as will be familiar to one of ordinary skill in the art. The DB 101 may also be accessed via Mobile Interface 130 by a mobile user 140 with a smartphone, tablet or the like via APIs 103 configured to allow such access, all enabled by Server-Side Code. Users may store file information such as profile information and the like using provided file storage 104.

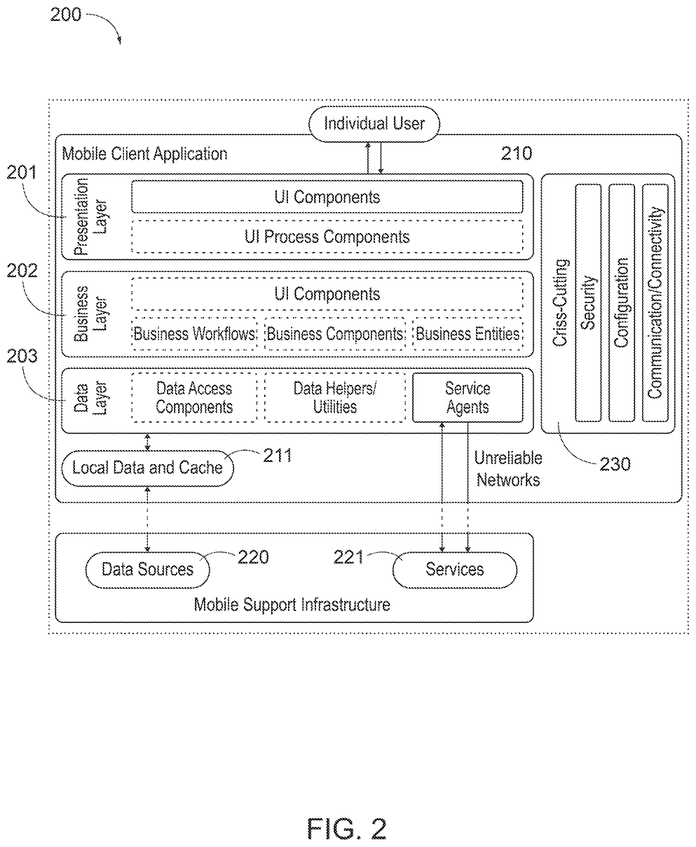

Turning now to FIG. 2, a three-tier architecture 200 as is commonly employed in the art may be employed according to the present disclosure, including a presentation layer 201, business layer 202 and data layer 203 within a mobile client application 210. User interface (UI) components 201a and UI process components 201b enable user interactivity with the mobile app. A business layer 202 of an exemplary embodiment comprises an application facade, business workflows, business components and business entities, while a data layer comprises data access components, data helpers/utilities and service agents. A local data cache may 211 be created to facilitate interactivity with data sources such as map applications 220, while service agents facilitate obtaining services 221 over unreliable networks. Cross-cutting features 230 within the mobile client application include security, configuration and communication/connectivity features.

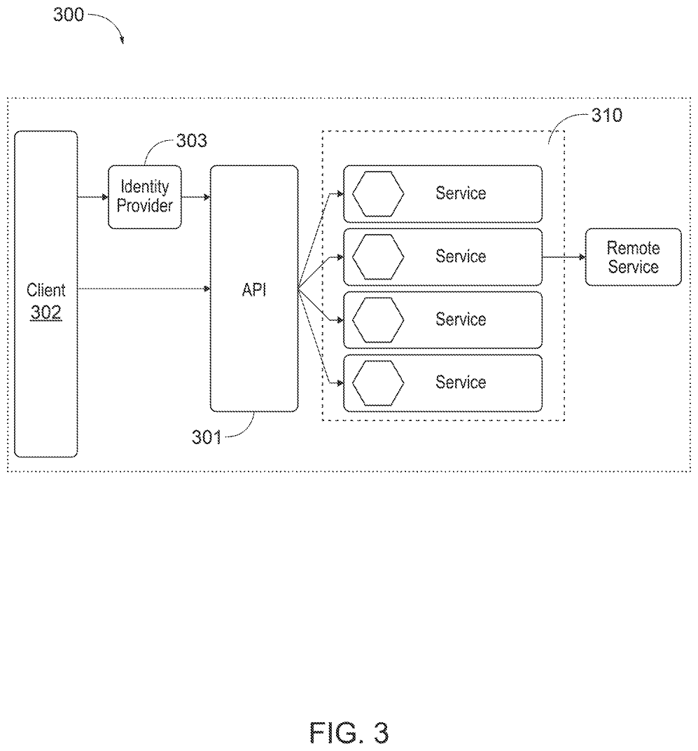

In certain embodiments, the present invention may rely on REST system architecture 300, as illustrated in FIG. 3. An API 301 of a system according to the present disclosure is exposed to a client 302 in a secure, uniform and stateless manner, and the client can then perform predefined operations using Restful Web Service, built on the hypertext transfer protocol (HTTP). As illustrated, an identity provider 303 may exist between the client 302 and API 301 to enable authentication, such as but not limited to OTP authentication. Through the API, available remote services may be accessed locally or remotely, i.e., via the Internet 310.

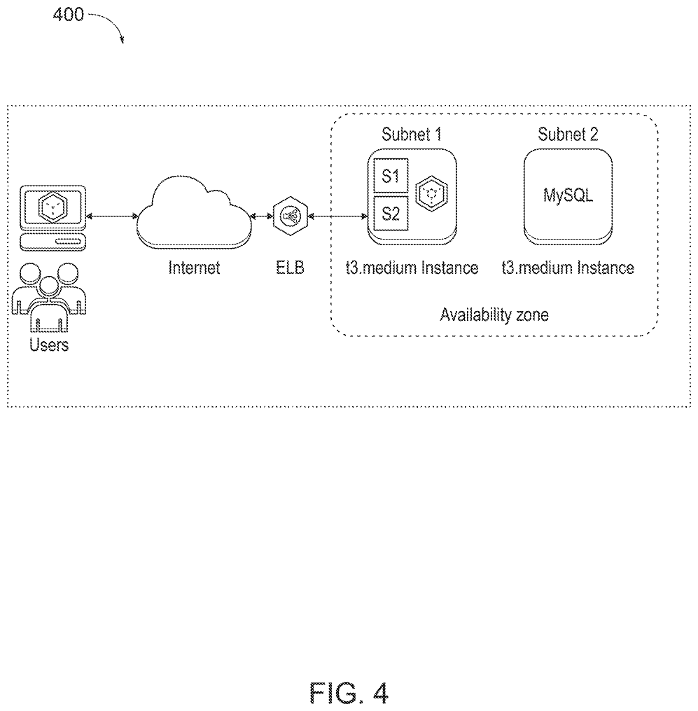

FIG. 4 illustrates a deployment architecture 400 of an exemplary embodiment of the present invention, showing the mapping of logical architecture to a physical environment. In a preferred embodiment, an available web service is utilized for cloud-based implementations of the methods of the present disclosure. As one of ordinary skill in the art will understand, web service instances comprising various combinations of processors, memory, storage and networking capabilities are available and a suitable instance may be selected to fit the use case. Each instance may be part of a virtual private cloud (VPC). As shown in FIG. 4, elastic load balancing (ELB) may be employed to automatically distribute application traffic across multiple targets and appliances within an availability zone depending on user needs. In the example shown in FIG. 4, users on the frontend connect to targets within an availability zone, such as a t3 medium instance database, or any other desired target, after load balancing. All functional requirements such as those described above are made available using this system architecture, and role-based permissions may be set (e.g., administrator or user).

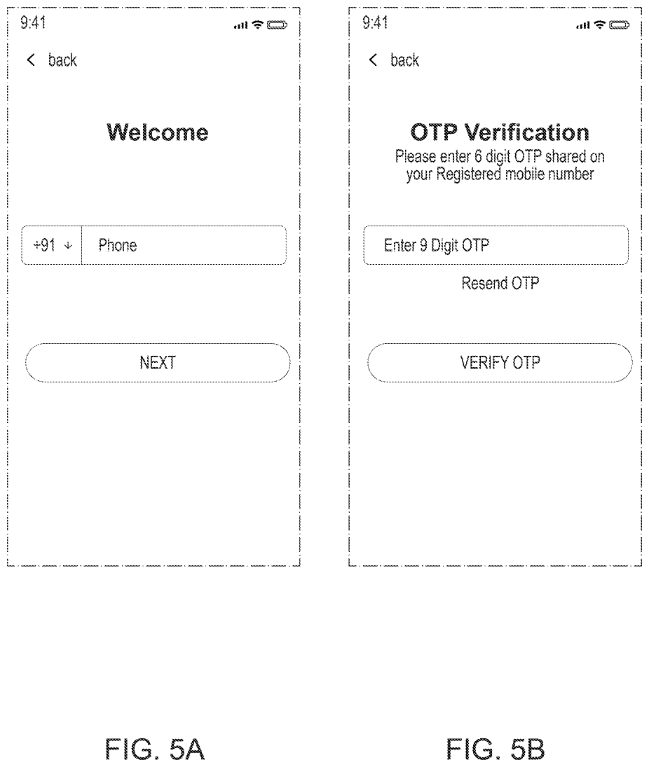

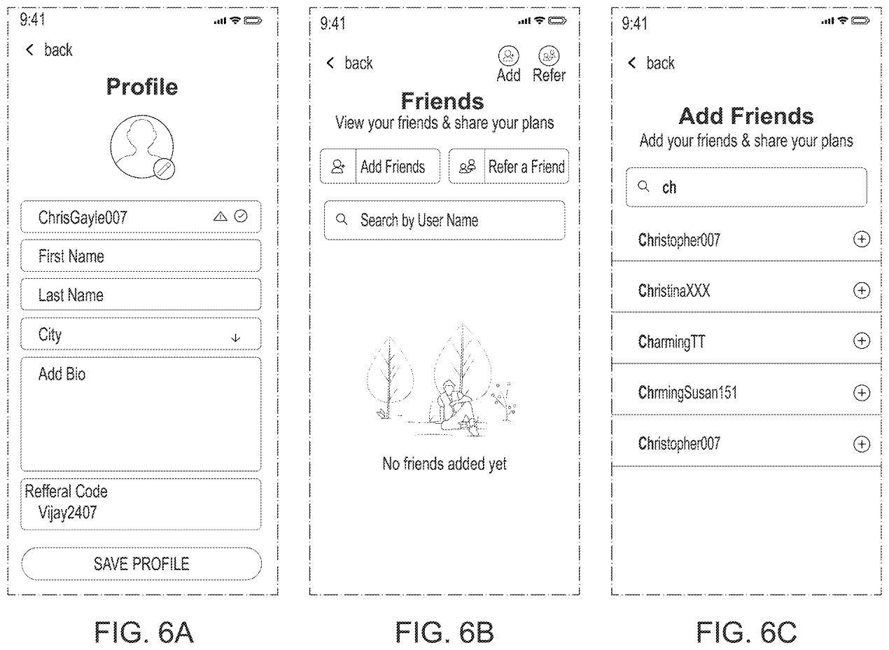

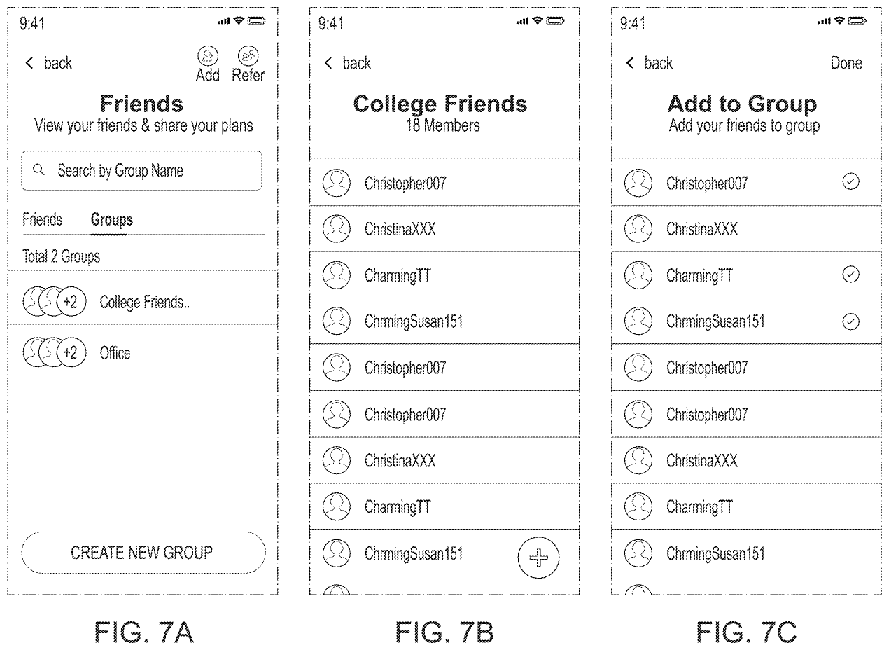

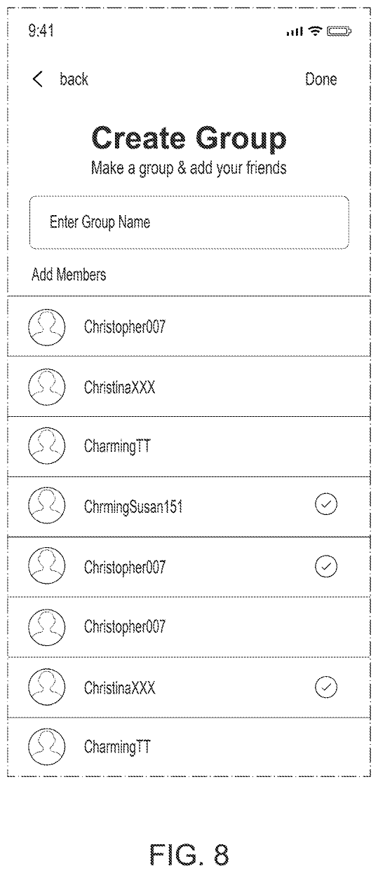

To better illustrate the functionality provided by a system according to the present invention, several screen shots are provided. Beginning with FIG. 5A and 5B, a login screen for signing onto the system is shown, which prompts OTP identify verification as shown in FIG. 5B. Once logged in, users may set up a profile using an interactive GUI (FIG. 6A), add friends or refer friends (FIGS. 6B and 6C), and this can be accomplished by viewing certain groups of friends (FIG. 7A), selecting friends from that group (FIG. 7B) or adding friends to that group (FIG. 7C). Additionally, a group may be created by naming a group and adding multiple friends or contacts to that group, as illustrated by the screen shot of FIG. 8.

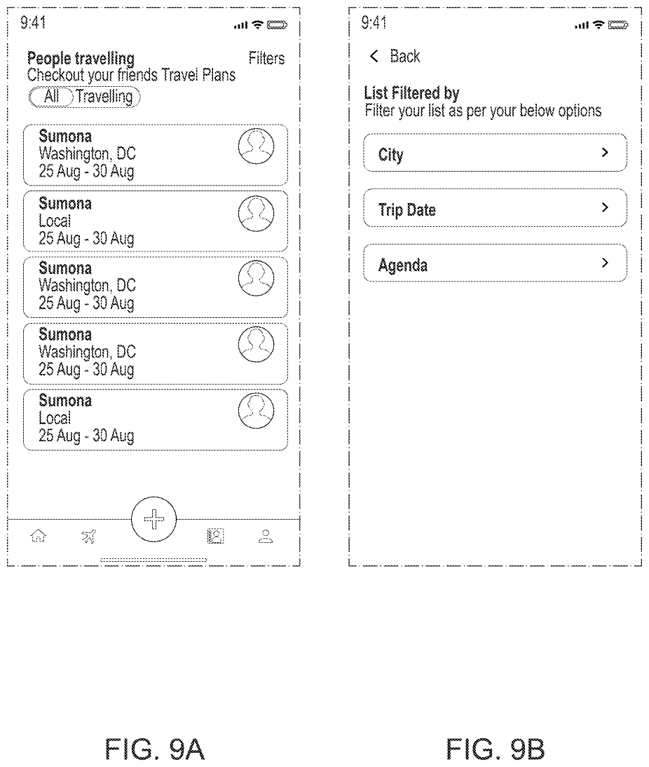

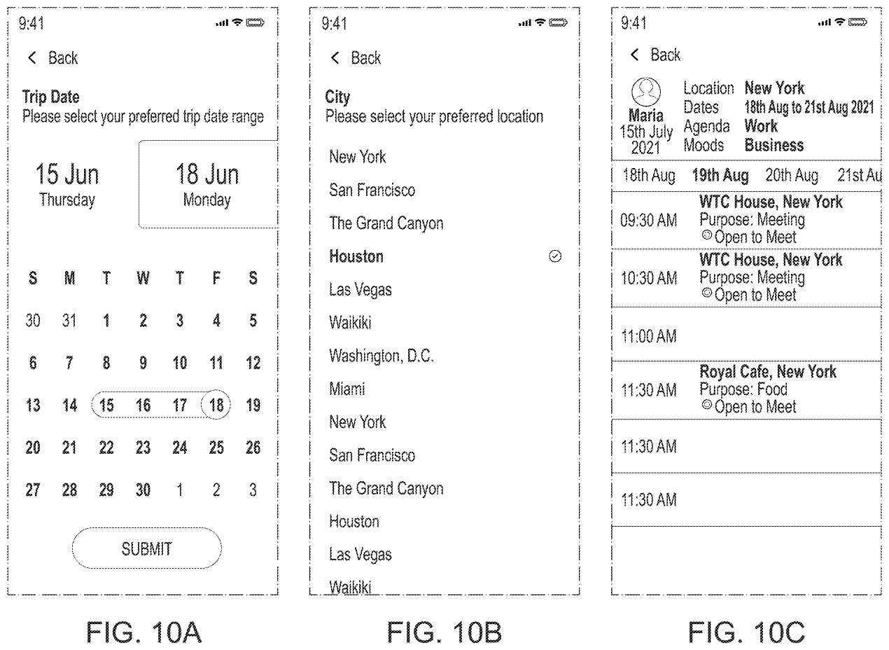

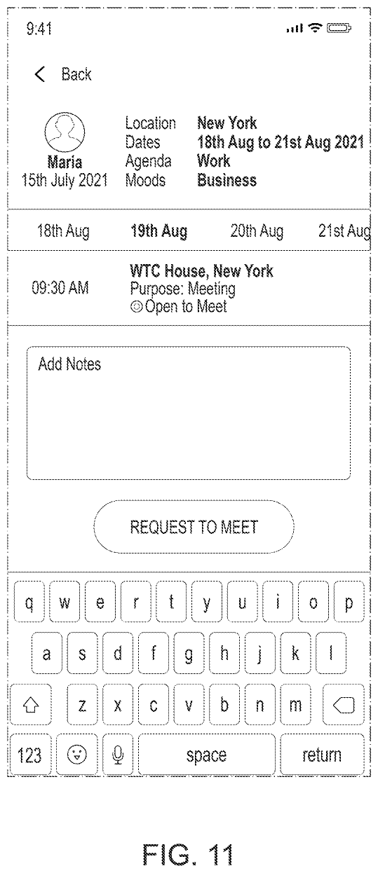

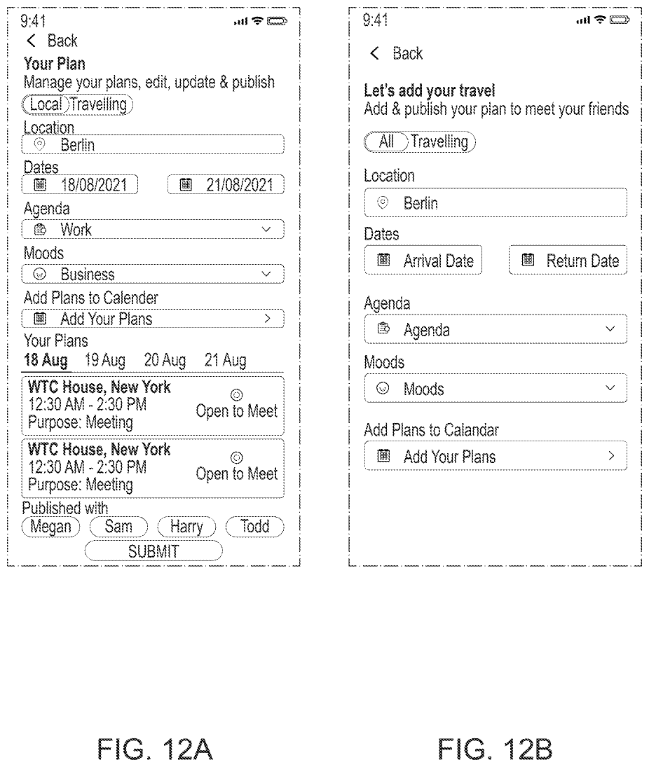

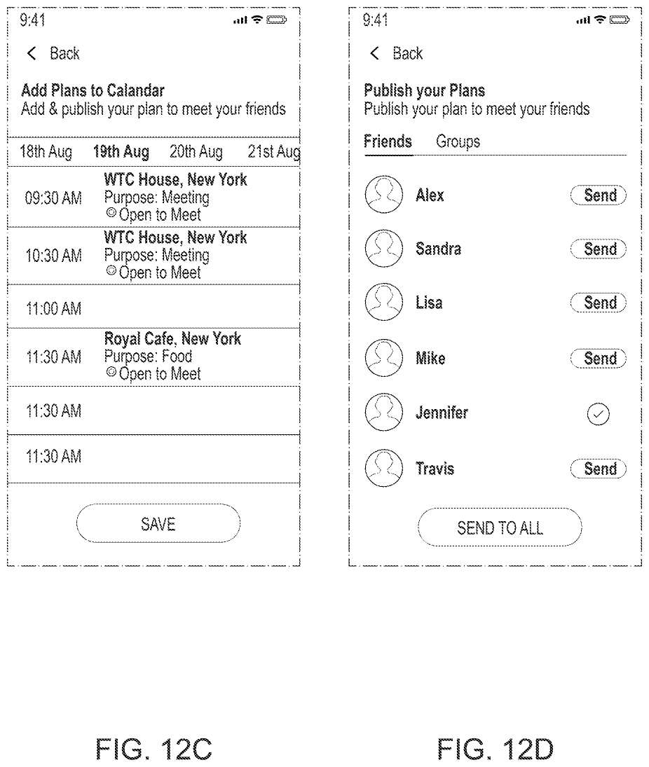

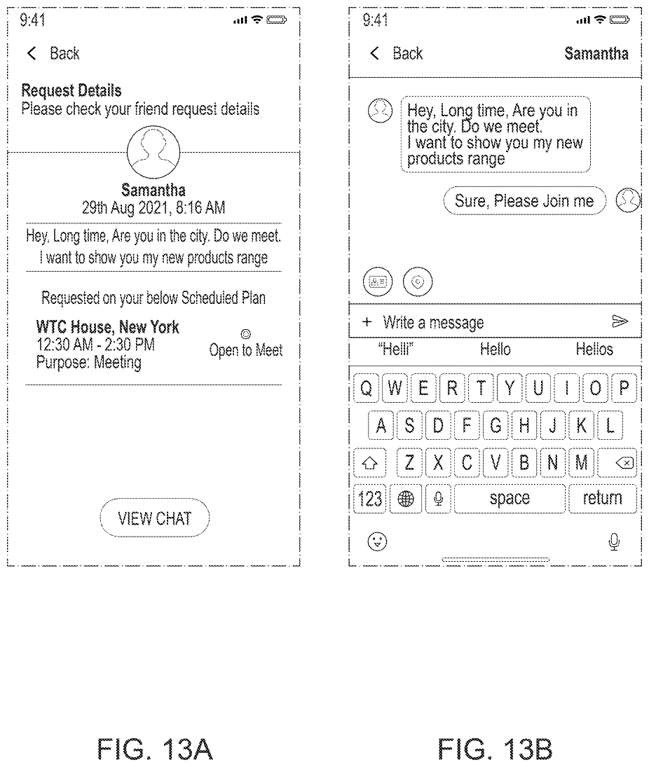

The travel plans of connections such as friends may be viewed on a GUI according to the present disclosure as depicted in FIG. 9A. Additionally, a user of a system according to the present invention may select cities and dates in order to determine which of their connections may be traveling to a certain destination, as illustrated in FIG. 9B. A GUI of the present may also allow a user to calendar trips by date and location, and then post daily schedules where downtime can be seen, all as illustrated in FIGS. 10A-10C. Users with visibility to this information may then request to meet the person on the trip during downtime, as illustrated in FIG. 11. FIGS. 12A-12D illustrate screen shots where users of a system of the present disclosure may publish plans, add travel, add plans to a calendar and publish plans to selected connections, respectively. Those connections who have visibility to the plans may then initiate contact and start a chat to determine whether physical meetings may be possible based on coincidence of time and location, as illustrated in FIGS. 13A and 13B.

The systems and methods described herein are intended to meet a long felt need in the art for a mobile app that is focused on making available times for physical meetings with selected connections visible and thus the scheduling of such meetings is made easier. While people are extremely efficient in planning work weeks and the like, people are inefficient in planning available time. The mobile app described herein helps people better understand what they could be doing with their personal time by providing an easy-to-use, efficient, effective tool to manage the events that people can take part in when available. In effect this tool is an effective way to manage downtime.

Today people use a variety of apps, calendars and mechanisms to make plans and coordinate schedules. No existing solution contains the full functionality or flexibility that is an object of the present invention, especially in the wake of COVID-19. There are social media apps, as well as calendar apps with invitation capabilities, but none focus on times when people are open for activities, and where. As such, the present invention vastly simplifies planning processes and facilitates in person connections and communications differently by aggregating information and planning differently than any existing solution today.

It is an object of the invention to address the issue of using multiple data sources and social media apps in an effort to coordinate and much more easily facilitate connecting with people in permitted social circles in a way that cannot be accomplished due to social and logistical challenges today, in one aspect by creating chat groups after formally inviting people to casual events, and creating independent calendar invitations for social events if they are a recurring or part of a schedule, such as that of a team sport. Users can actively invite others, or instead you can show where and when they might be available. An exemplary system according to the present disclosure manually aggregates information from various social media apps and then adds it to calendars, and separately manages calendars and chat groups. These and other useful features for identifying downtimes and scheduling physical meetings during those times will be apparent to one of ordinary skill in the art in view of the present disclosure.

What is claimed is:

1. A system for facilitating physical connections among people, the system comprising:
a software application tangibly stored on a non-transitory computer readable medium, in network communication with at least one computing device over at least one application programming interface (API), the at least one API being in further communication with a database and a file storage component;
wherein the at least one computing device comprises a mobile client application having a presentation layer, a business layer and a data layer, the data layer being in network communication with at least one data source and at least one web service;
wherein the presentation layer comprises a graphical user interface (GUI) which enables a user of the at least one computing device to initiate an instruction from the software application, which when executed by a connected processor causes the processor to carry out at least one task selected from the group consisting of:
logging into the system, creating a user profile, connecting to other users of the system, creating a group of users of the system, viewing plans published by other users of the system, request meetings with other users of the system, creating plans to meet with other users of the system, share plans with other users of the system including times and locations, or combinations thereof.

2. The system of claim 1, wherein the non-transitory computer readable medium is a web server.

3. The system of claim 1, wherein the presentation layer comprises user interface (UI) components and UI process components responsive to instructions from an individual user.

4. The system of claim 1, wherein the business layer includes components selected from the group consisting of an application facade, business workflows, business components, business entities and combinations thereof.

5. The system of claim 1, wherein the data layer includes components selected from the group consisting of data access components, data utilities, service agents and combinations thereof.

6. The system of claim 1, wherein the mobile client application further comprises a mobile support infrastructure having data sources in communication with a cache of the mobile client application.

7. The system of claim 1, wherein the mobile client application comprises at least one cross-cutting feature selected from the group consisting of security features, configuration features, communication features and combinations thereof.

8. The system of claim 1, further comprising a deployment architecture enabling a mapping of a logical architecture to a physical environment.

9. The system of claim 1, further comprising an elastic load balancing (ELB) component that automatically distributes application traffic across multiple targets and appliances within an availability zone depending on user needs.

10. The system of claim 9, wherein users on a frontend connect to targets within an availability zone after load balancing.

11. A method for facilitating physical connections among people, the method comprising the steps of:
logging into a system according to claim 1; and
executing at least one task selected from the group consisting of:
creating a user profile, connecting to other users of the system, creating a group of users of the system, viewing plans published by other users of the system, request meetings with other users of the system, creating plans to meet with other users of the system, share plans with other users of the system including times and locations, or combinations thereof.

12. The method of claim 11, wherein the non-transitory computer readable medium of the system according to claim 1 is a web server.

13. The method of claim 11, wherein the presentation layer of the mobile client application of the system according to claim 1 comprises user interface (UI) components and UI process components responsive to instructions from an individual user.

14. The method of claim 11, wherein the wherein the business layer of the mobile client application of the system according to claim 1 includes components selected from the group consisting of an application facade, business workflows, business components, business entities and combinations thereof.

15. The method of claim 11, wherein the wherein the data layer of the mobile client application of the system according to claim 1 includes components selected from the group consisting of data access components, data utilities, service agents and combinations thereof.

16. The method of claim 11, wherein the mobile client application of the system according to claim 1 further comprises a mobile support infrastructure having data sources in communication with a cache of the mobile client application.

17. The method of claim 11, wherein the mobile client application of the system according to claim 1 comprises at least one cross-cutting feature selected from the group consisting of security features, configuration features, communication features and combinations thereof.

18. The method of claim 11, wherein the system according to claim 1 further comprises a deployment architecture enabling a mapping of a logical architecture to a physical environment.

19. The method of claim 11, wherein the system according to claim 1, further comprises an elastic load balancing (ELB) component that automatically distributes application traffic across multiple targets and appliances within an availability zone depending on user needs.

20. The method of claim 19, wherein users on a frontend connect to targets within an availability zone after load balancing.
